(19) United States
(12) Patent Application Publication
(10) Pub. No.: US 2002/0078184 A1
(43) Pub. Date: Jun. 20, 2002

(54) Record medium, multicast delivery method and multicast receiving method

(76) Inventors: Eiji Ujyo, Kanagawa (JP); Kazuyoshi Suzuki, Kanagawa (JP)

Correspondence Address: STAAS & HALSEY LLP, 700 11TH STREET, NW, SUITE 500, WASHINGTON, DC, 20001, US

(21) Appl. No.: 10/006,705

(22) Filed: Dec. 10, 2001

(30) Foreign Application Priority Data
Dec. 18, 2000 (JP) 2000-383646

(51) Int. Cl. G06F 15/177; G06F 15/173

(52) U.S. Cl. 709/220; 709/225

(57) ABSTRACT

A multicast delivery system that prevents data from being lost. A group generating section in a multicast delivery unit divides data to be delivered stored in a database to generate a plurality of groups. A delivery times determining section determines the number of times each group is delivered. A delivering section repeats delivery of each group times determined by the delivery times determining section. In a multicast receiving unit, a receiving preparing section prepares receiving according to control information delivered by a control information delivering section before delivery of data, so a data packet receiving section can receive delivered data smoothly. When the receiving of the entire data is completed, a received data quality judging section judges whether the receiving was performed normally and informs a judgment responding section of a judgment. The judgment responding section waits waiting time a waiting time calculating section calculated by the use of a random number and then sends the judgment.

### BACKGROUND OF THE INVENTION

1. Field of the Invention

This invention relates to a record medium, multicast delivery method, and multicast receiving method and, more particularly, to a record medium that stores a program for making a computer perform the multicast process of delivering information to a plurality of delivery destinations like broadcasting, computer-readable record medium that stores a program for making a computer perform the process of receiving data packets multicasted from a delivery source, multicast delivery method for delivering information to a plurality of delivery destinations like broadcasting, and multicast receiving method for receiving data packets multicasted from a delivery source.

2. Description of the Related Art

With communication called multicast delivery in which the same data is delivered from one delivery source system to a plurality of delivery destination systems, user datagram protocol (UDP), being connectionless communication, is usually used as a communication method.

FIG. 18 is a view showing an example of conventional multicast delivery systems using the UDP.

In FIG. 18, a delivery requesting company 10 is a company which requests delivery of data. A delivery source system 11 sends information to delivery destination systems 15 through 17 via a parabola antenna 12, satellite 13, and satellite network 14 by the use of UDP.

FIG. 19 is a view showing in detail the structure of the delivery source system 11. As shown in FIG. 19, the delivery source system 11 comprises a main unit 11b including a data management section 11b-1, data transfer section 11b-2, and communication control section 11b-3 and a database 11a. The database 11a stores data to be delivered until the delivery is completed. The data management section 11b-1 manages data stored in the database 11a. The data transfer section 11b-2 transfers data to be delivered to the communication control section 11b-3 in compliance with instructions from the data management section 11b-1. The communication control section 11b-3 divides data transferred into packets of predetermined size and provides them to the parabola antenna 12.

The parabola antenna 12 converts data supplied from the delivery source system 11 into electronic waves and sends them to the satellite 13.

The satellite 13 receives electronic waves sent from the parabola antenna 12, performs frequency conversion and amplification processes on them, and sends them to the delivery destination systems 15 through 17.

The satellite network 14 is a pseudo one-way network formed by electronic waves delivered from the satellite 13.

The delivery destination systems 15 through 17 receive electronic waves sent from the satellite 13 in compliance with UDP and send data indicating the result of receiving to the delivery source system 11 via a ground wire network 18.

The ground wire network 18 consists of, for example, the Internet and sends information, being responses from the delivery destination systems 15 through 17, to the delivery source system 11.

Now, operation in the above conventional multicast delivery system will be described in brief.

Data (regarding an advertisement, for example) delivery of which was requested by the delivery requesting company 10 is provided to the database 11a in the delivery source system 11 and is stored there.

In the delivery source system 11, the communication control section 11b-3 divides the data supplied from the delivery requesting company 10 into packets in compliance with UDP, adds header information which indicates that the packets will be delivered by multicasting to the packets, and provides the packets to the parabola antenna 12.

The parabola antenna 12 modulates electronic waves, being a carrier, according to the packets it received and sends the electronic waves to the satellite 13.

The satellite 13 performs frequency conversion and power amplification processes on the electronic waves it received and sends the electronic waves to the delivery destination systems 15 through 17.

The delivery destination systems 15 through 17 receive and demodulate the electronic waves sent from the satellite 13 and extract data from them. If the delivery destination systems 15 through 17 could receive the entire data normally, they will inform the delivery source system 11 about it. This information is used for, for example, accounting.

The delivery source system 11 performs processes, such as accounting, for each delivery destination system on the basis of the results it received.

The above operation enables the same data to be delivered to the delivery destination systems 15 through 17 by multicasting.

By the way, with conventional multicast delivery methods, there are cases where the possibility that delivered data may be lost on a communication line is not taken into consideration. In such cases, it can be impossible to receive data normally.

In some systems, a delivery destination system which could not normally receive data informs the delivery source system 11 about it and the delivery source system 11 resends the data to the delivery destination system. However, the entire data is sent in the case of resending. As a result, if a disturbance occurs on a communication line with a certain probability, the disturbance will influence data resent with the same probability. Therefore, if there is a large amount of data, it is difficult to receive the data normally.

Moreover, as soon as the delivery destination systems 15 through 17 finish receiving data, they will inform the delivery source system 11 about the result of the receiving. The delivery destination systems 15 through 17 tend to give this notification at the same time, so the delivery source system 11 cannot process it. This will degrade the performance of the entire system. In addition, if the delivery destination systems 15 through 17 use dial-up connection, an interval between the time when a request to send data is made and the time when the data is actually sent may become longer. In such cases, the load on users who own the delivery destination systems 15 through 17 will increase.

### SUMMARY OF THE INVENTION

The present invention was made under the background circumstances as described above. An object of the present invention therefore is to provide a multicast delivery method which enables normal delivery of data even in the case of a disturbance occurring on, for example, a communication line, and a record medium on which a program for realizing such a method is recorded.

Another object of the present invention is to provide a multicast receiving method in a multicast delivery method which enables to inform a delivery source system about the result of receiving without increasing the load on a system, and a record medium on which a program for realizing such a method is recorded.

In order to achieve the above first object, a multicast delivery method for delivering information to a plurality of delivery destinations like broadcasting is provided. This multicast delivery method comprises a group generating step for generating groups including at least one data packet from a group of data packets to be delivered, a delivery times determining step for determining the number of times each of the groups generated by the group generating step is delivered, and a delivering step for repeating delivery of each of the groups generated by the group generating step times determined by the delivery times determining step.

In order to achieve the above second object, a multicast receiving method for receiving data packets multicasted from a delivery source is provided. This multicast receiving method comprises a control information receiving step for receiving control information delivered from a delivery source before a data packet, a receiving preparing step for preparing receiving the data packet according to the control information, and a data packet receiving step for receiving the data packet delivered from the delivery source after the control information.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a view for describing the operative principles of the present invention.

FIG. 2 is a view showing the structure of an embodiment of the present invention.

FIG. 3 is a view showing in detail the structure of the delivery source system shown in FIG. 2.

FIG. 4 is a view showing in detail the structure of the delivery destination systems shown in FIG. 2.

FIG. 5 is a signal flow chart for describing a data flow in the case of delivering data from a delivery source system to delivery destination systems by multicasting.

FIGS. 6(A), 6(B) and 6(C) are views showing in detail packet information, file information, and destination information respectively.

FIG. 7 is a view showing the correspondences among files, groups, and packets in the case of the groups being resent once.

FIG. 8 is a view showing an example of control data sent to a delivery destination system.

FIG. 9 is a view showing how groups are delivered in the case of the number of times groups are resent being set to two.

FIG. 10 is a view showing an example of notification of delivery result.

FIG. 11 is a view showing in detail the entry information shown in FIG. 10.

FIG. 12 is a view showing in detail the entry ID shown in FIG. 10.

FIGS. 13(A) and 13(B) are views showing examples of data stored in the entry data shown in FIG. 10.

FIG. 14 is a flow chart for describing an example of processes performed in a delivery source system.

FIG. 15 is a flow chart for describing an example of the process of generating result notification information shown in FIG. 14.

FIG. 16 is a flow chart for describing an example of a process performed in a delivery destination system.

FIG. 17 is a flow chart for describing an example of the process of calculating delivery result waiting time shown in FIG. 16.

FIG. 18 is a view showing the structure of a conventional multicast delivery system.

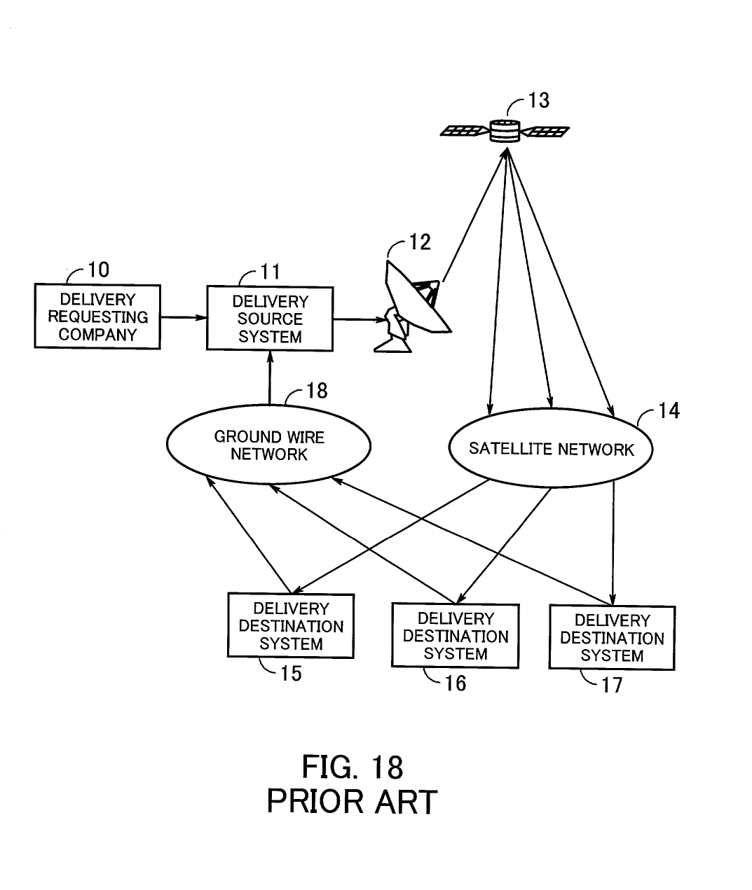

FIG. 19 is a view showing the structure of the delivery source system shown in FIG. 18.

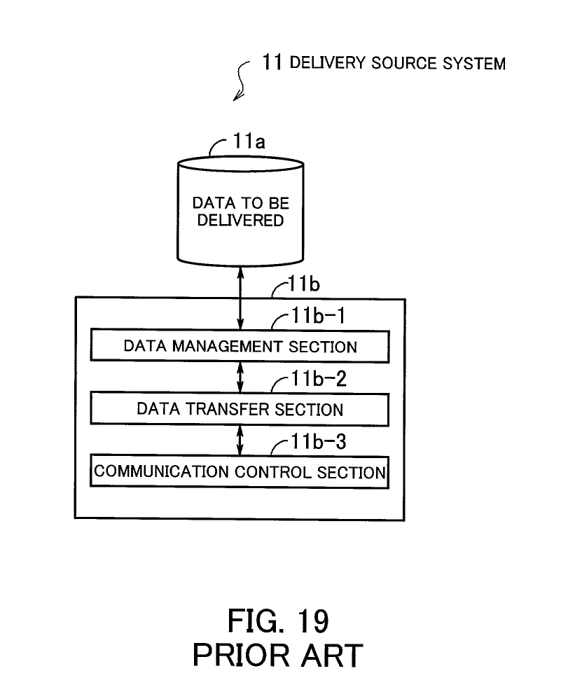

### DESCRIPTION OF THE PREFERRED EMBODIMENT

An embodiment of the present invention will now be described with reference to the drawings.

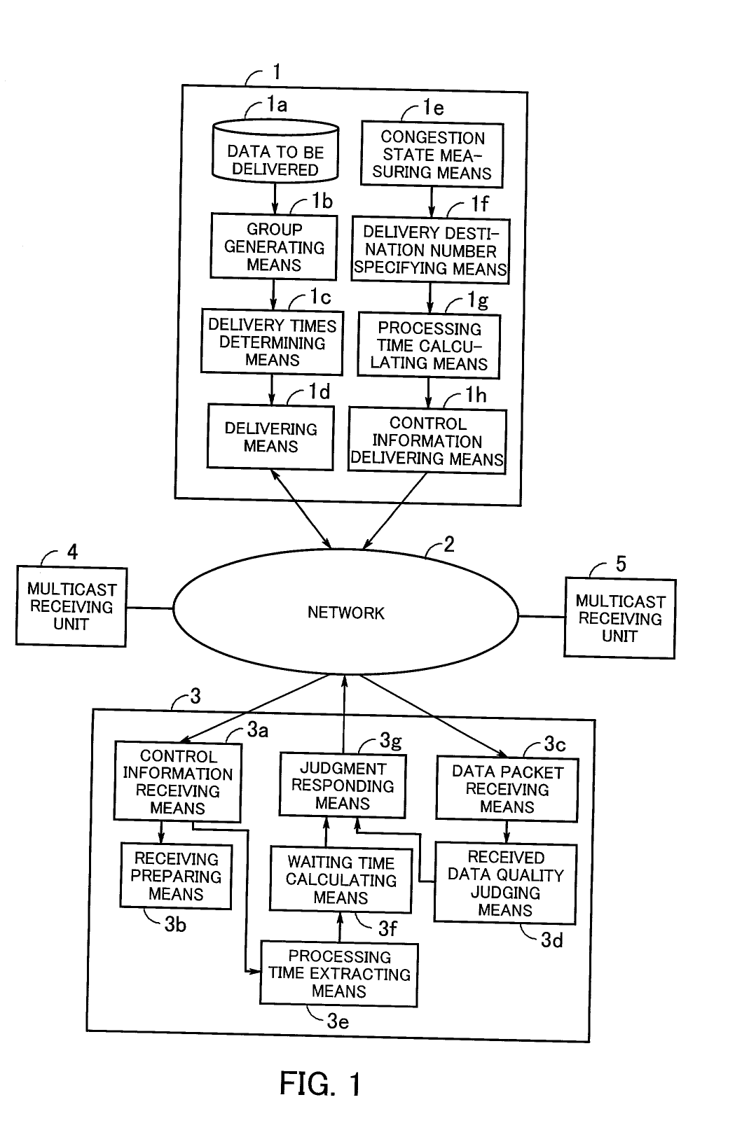

FIG. 1 is a view for describing the operative principles of the present invention. In FIG. 1, a multicast delivery unit 1 for realizing a multicast delivery method according to the present invention comprises a database 1a, group generating means 1b, delivery times determining means 1c, delivering means 1d, congestion state measuring means 1e, delivery destination number specifying means 1f, processing time calculating means 1g, and control information delivering means 1h and delivers data to multicast receiving units 3 through 5, being a plurality of delivery destinations connected to a network 2, by multicasting.

The database 1a consists of, for example, a hard disk drive (HDD) and stores data to be delivered.

The group generating means 1b generates groups including at least one data packet in the case of dividing data into packets.

The delivery times determining means 1c determines the number of times each of groups generated by the group generating means 1b is delivered.

The delivering means 1d repeats delivery of each of groups generated by the group generating means 1b times determined by the delivery times determining means 1c.

The congestion state measuring means 1e measures the congestion state of a system.

The delivery destination number specifying means 1f specifies the number of multicast receiving units, to which data is delivered.

The processing time calculating means 1g refers to a congested state and the number of delivery destinations and calculates time needed for the entire process (processing time) in the case of responses being given by delivery destinations.

The control information delivering means 1h delivers control information, which is necessary for controlling in the case of receiving data to be delivered, before the delivering means 1d delivers the data.

The network 2 consists of, for example, the Internet.

The multicast receiving unit 3 for realizing a multicast receiving method according to the present invention comprises control information receiving means 3a, receiving preparing means 3b, data packet receiving means 3c, received data quality judging means 3d, processing time extracting means 3e, waiting time calculating means 3f, and judgment responding means 3g. The multicast receiving unit 3 receives data delivered from the multicast delivery unit 1 and informs about the result of the receiving.

The control information receiving means 3a receives control information delivered from the multicast delivery unit 1 before a data packet.

The receiving preparing means 3b prepares receiving a data packet according to control information.

The data packet receiving means 3c receives a data packet delivered from the multicast delivery unit 1 after control information.

The processing time extracting means 3e extracts processing time the multicast delivery unit 1 will take to process responses from all of the multicast receiving units 3 through 5 from control information.

The waiting time calculating means 3f multiplies processing time and a random number together to calculate waiting time before the judgment responding means 3g responding.

The judgment responding means 3g sends the judgment of the received data quality judging means 3d about receiving to the multicast delivery unit 1 at the time when waiting time calculated by the waiting time calculating means 3f elapsed.

The structure of the multicast receiving units 4 and 5 is the same as that of the multicast receiving units 3, so descriptions of them will be omitted.

Now, operation in FIG. 1 will be described.

When the multicast delivery unit 1 delivers data, the group generating means 1b obtains data to be delivered from the database 1a, divides it into packets, and generates groups including at least one packet. For example, hundred packets are treated as one group. The groups generated in this way are provided to the delivering means 1d via the delivery times determining means 1c.

The delivery times determining means 1c determines the number of times each group is sent. For example, the delivery times determining means 1c determines that each group is sent twice, and informs the delivering means 1d of it.

Before the delivering means 1d performs delivery of the data, the congestion state measuring means 1e measures the congestion state of the multicast delivery unit 1 and informs the delivery destination number specifying means 1f of it.

The delivery destination number specifying means 1f specifies the number (three, in this example) of multicast receiving units, being delivery destinations, and provides it to the processing time calculating means 1g, together with the congestion state.

The processing time calculating means 1g refers to the congestion state supplied from the congestion state measuring means 1e and the number of delivery destinations specified by the delivery destination number specifying means 1f and calculates time needed for the entire process in the case of data indicative of the result of receiving being sent from the multicast receiving units 3 through 5.

The control information delivering means 1h sends the processing time calculated by the processing time calculating means 1g and information regarding the data to be sent now, such as the number of packets included in each group and the amount of the entire data, to the multicast receiving units 3 through 5 as control information before sending actual data.

The multicast receiving units 3 through 5 receive the control information and prepare receiving the actual data sent after it. If the multicast receiving unit 3 is taken as an example, the control information is received by the control information receiving means 3a and is provided to the receiving preparing means 3b and processing time extracting means 3e.

The receiving preparing means 3b refers to the control information supplied and makes preparations, such as ensuring necessary buffer areas, necessary for receiving the actual data. A process regarding the processing time extracting means 3e will be described later.

After the preparations for receiving is completed in this way, the delivering means 1d in the multicast delivery unit 1 repeats delivery of the data times determined by the delivery times determining means 1c with each of the groups generated by the group generating means 1b as a sending unit. For example, if the number of times the data is delivered is two, the first group is sent twice in succession. Then delivery of the second group is begun. The data will be delivered in this way.

Operation in the multicast receiving units 3 through 5 is the same, so operation only in the multicast receiving unit 3 will now be described. The data packet receiving means 3c in the multicast receiving unit 3 receives a data packet sent from the multicast delivery unit 1 and stores it in a buffer (not shown) prepared by the receiving preparing means 3b.

The received data quality judging means 3d judges whether the received data is normal or not. If the received data is not normal, the received data quality judging means 3d judges whether another group can be substituted for the received data or complement it. If another group can be substituted for the received data or complement it, this group is used as a substitute for or complement to it. In addition, the received data quality judging means 3d judges that this group was received normally, and informs the judgment responding means 3g of it. If there is no group that can be substituted for the received data or complement it, the received data quality judging means 3d judges that the data could not be received normally, and informs the judgment responding means 3g of it.

After receiving is completed, the judgment responding means 3g waits until waiting time calculated by the waiting time calculating means 3f elapses, and then sends a judgment to the multicast delivery unit 1. Waiting time calculated by the waiting time calculating means 3f is generated by multiplying processing time (which will be needed to process judgments from all of the multicast receiving units 3 through 5) extracted from the control information by the processing time extracting means 3e and a random number between, for example, 0 and 1 together. The same process will also be performed in the multicast receiving units 4 and 5. Random numbers generated in the multicast receiving units 3 through 5 are different from one another, so waiting time obtained differs among the multicast receiving units 3 through 5. Therefore, the multicast receiving units 3 through 5 wait a time, which differs among them, and then send judgments to the multicast delivery unit 1.

The multicast delivery unit 1 receives these judgments. If there is a multicast receiving unit which could not receive normally, the multicast delivery unit 1 will specify the IP address of this unit and deliver the data again.

As described above, in the present invention, control information is sent before delivery of actual data and preparations for receiving are made at the receiving end. Therefore, data can be received under optimum conditions, resulting in a smaller number of errors at the receiving end.

In addition, in the present invention, a group is set as a sending unit and each group is sent two or more times. Therefore, even if an error occurs on, for example, a communication line, it can be corrected.

Furthermore, in the present invention, time needed for a receiving process is calculated in advance at the sending end and waiting time is calculated from the time and a random number at the receiving end. This can prevent congestion of notification of receiving result sent from the receiving end and reduce the load on the network 2.

An embodiment of the present invention will now be described.

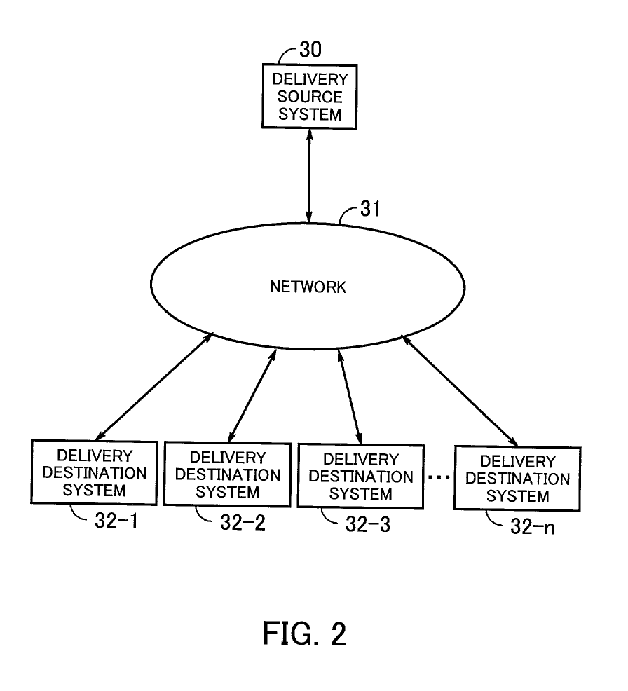

FIG. 2 is a view showing the structure of an embodiment of the present invention. In FIG. 2, a delivery source system 30 sends information to delivery destination systems 32-1 through 32-n by multicasting.

A network 31 is bidirectional telecommunication means and consists of, for example, the Internet.

The delivery destination systems 32-1 through 32-n receive information delivered from the delivery source system 30 by multicasting, inform the delivery source system 30 about the result of the receiving, and perform various processes on the basis of the information they received.

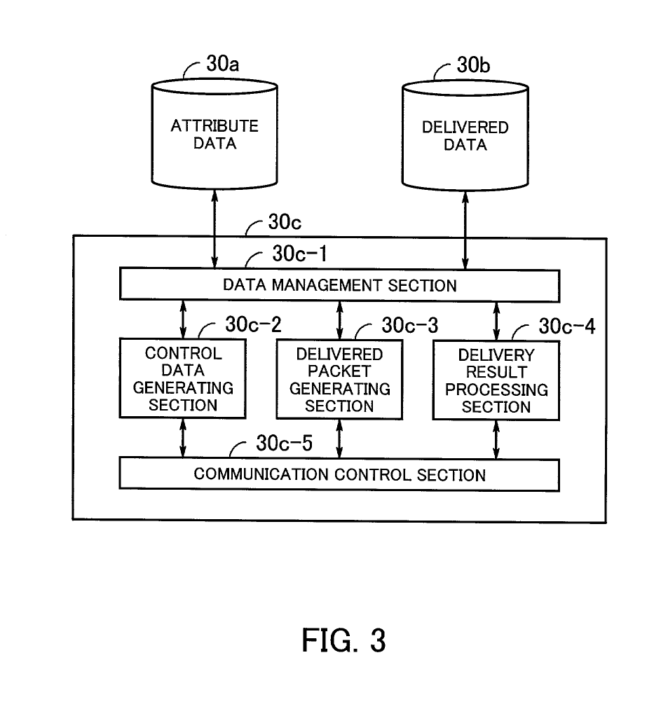

FIG. 3 is a view showing in detail the structure of the delivery source system 30 shown in FIG. 2. In FIG. 3, a database 30a stores attribute data, such as packet information, file information, and destination information.

A database 30b stores data, being actual data.

A main unit 30c includes a data management section 30c-l, control data generating section 30c-2, delivered packet generating section 30c-3, delivery result processing section 30c-4, and communication control section 30c-5.

The data management section 30c-1 manages attribute data stored in the database 30a and delivered data stored in the database 30b and controls each section in the unit.

The control data generating section 30c-2 generates control data in compliance with instructions from the data management section 30c-1 by referring to attribute data corresponding to delivered data to be sent.

The delivered packet generating section 30c-3 generates delivered packets in compliance with instructions from the data management section 30c-1 and provides them to the communication control section 30c-5.

The delivery result processing section 30c-4 processes notification of delivery result sent from the delivery destination systems 32-1 through 32-n and measures the congestion state of the system.

The communication control section 30c-5 delivers data to be delivered and control data to the delivery destination systems 32-1 through 32-n and receives notification of delivery result sent from the delivery destination systems 32-1 through 32-n, in compliance with instructions from an upper layer.

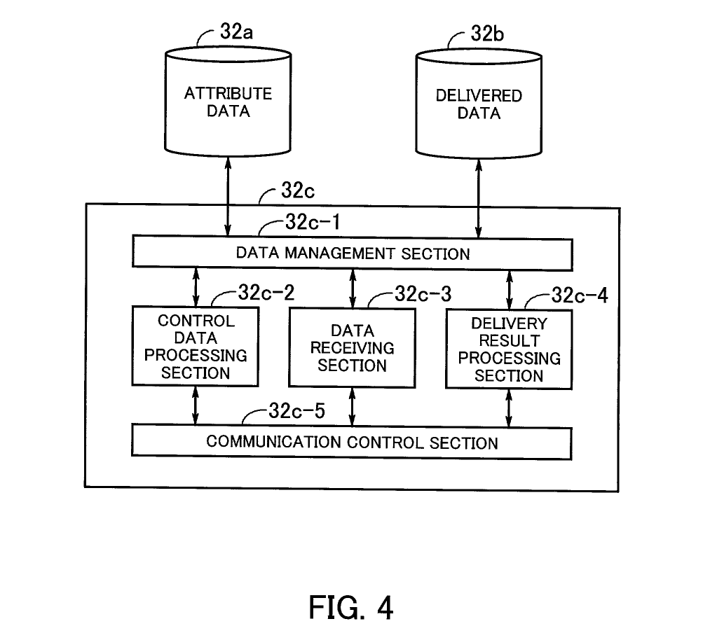

FIG. 4 is a view showing in detail the structure of the delivery destination systems 32-1 through 32-n shown in FIG. 2. In FIG. 4, a database 32a stores attribute data, such as packet information, file information, and destination information, the delivery destination systems 32-1 through 32-n received from the delivery source system 30.

A database 32b stores delivered data, being actual data, the delivery destination systems 32-1 through 32-n received from the delivery source system 30.

A main unit 32c includes a data management section 32c-1, control data processing section 32c-2, data receiving section 32c-3, delivery result processing section 32c-4, and communication control section 32c-5.

The data management section 32c-1 manages attribute data stored in the database 32a and delivered data stored in the database 32b and controls each section in the unit.

The control data processing section 32c-2 analyzes control data the delivery destination systems 32-1 through 32-n received and performs a process corresponding to analysis results.

The data receiving section 32c-3 receives delivered packets in compliance with instructions from the data management section 32c-1. Furthermore, the data receiving section 32c-3 waits until the receiving of all of the packets included in a group of which the data management section 32c-1 informed it is completed, and provides data it received to the data management section 32c-1 at the time when all of the packets have been received.

The delivery result processing section 32c-4 generates notification of delivery result and gives the notification to the communication control section 32c-5, under the control of the data management section 32c-1.

The communication control section 32c-5 receives delivered data and control data and sends notification of the delivery result to the delivery source system 30, in compliance with instructions from an upper layer.

Now, operation in the above embodiment will be described.

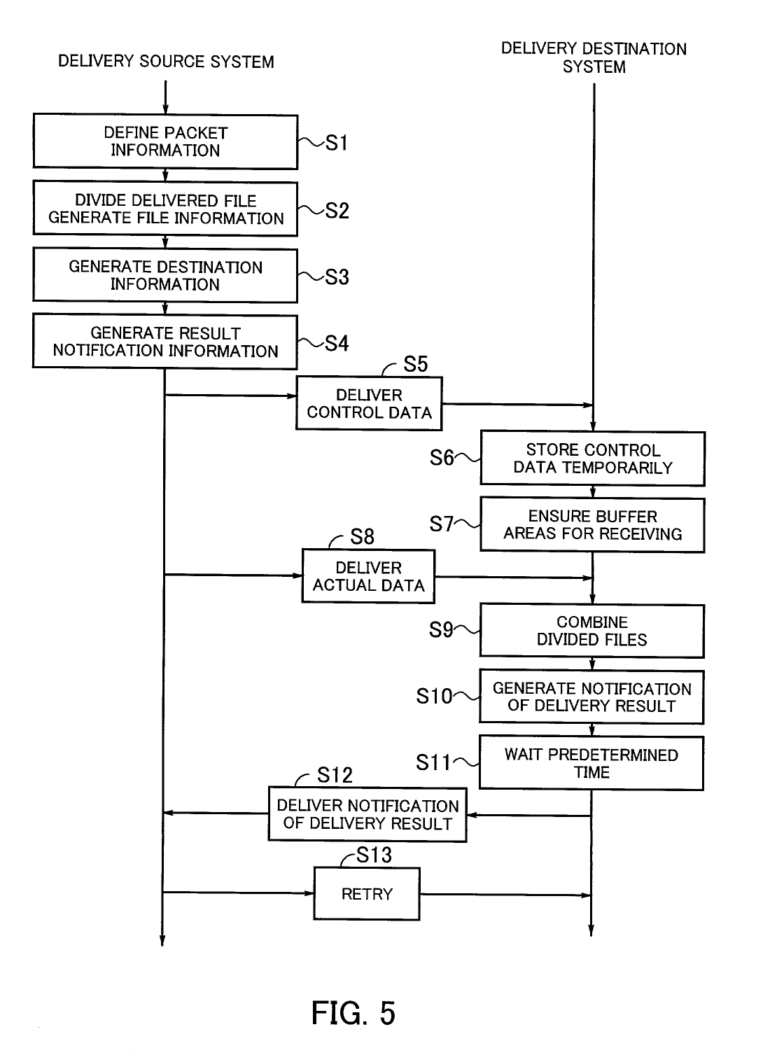

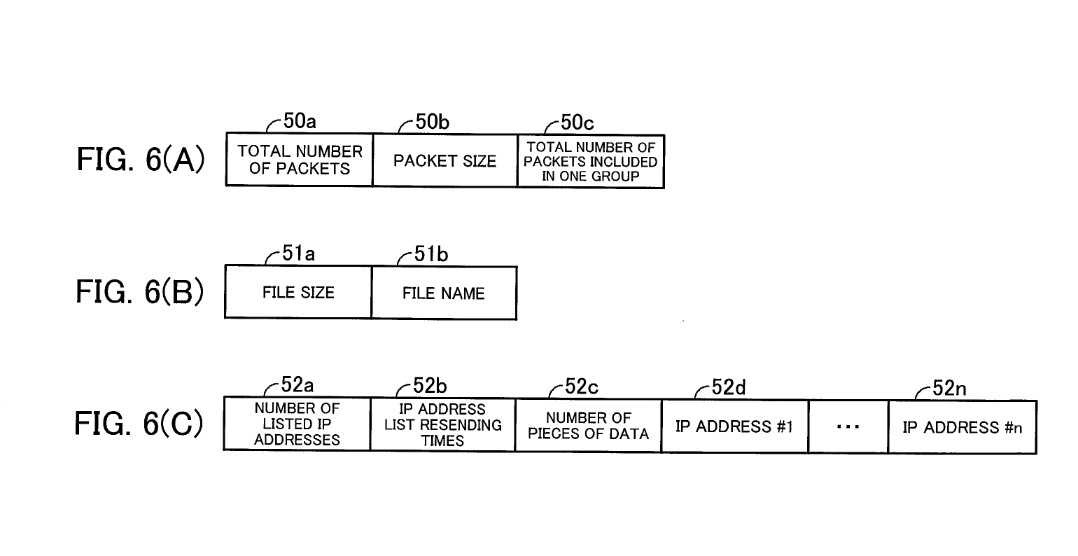

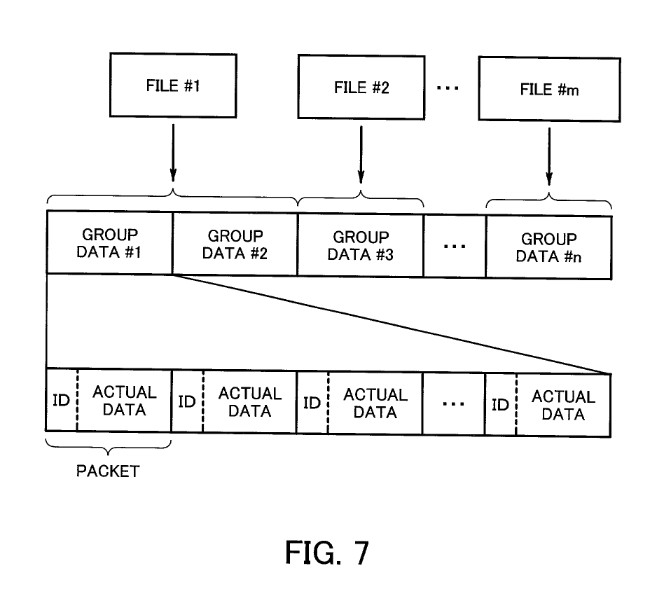

FIG. 5 is a signal flow chart showing how data is exchanged between the delivery source system 30 and delivery destination systems 32-1 through 32-n in the case of delivering data from the delivery source system 30 to the delivery destination systems 32-1 through 32-n by multicasting.

[Step S1] The control data generating section 30c-2 obtains attribute data for data to be delivered from the database 30a to define packet information. As shown in FIG. 6(A), this packet information includes Total Number of Packets 50a, Packet Size 50b, and Total Number of Packets Included in One Group 50c. Total Number of Packets 50a indicates the total number of packets to be delivered. Packet Size 50b indicates the data length of a packet. Total Number of Packets Included in One Group 50c indicates the number of packets included in a group, being a basic unit for delivery.

[Step S2] The delivered packet generating section 30c-3 obtains a file regarding the data to be delivered from the database 30b and divides it according to the amount of data included in a group (=total number of packets included in one group×packet size). Divided files are divided further into packets. FIG. 7 is a view showing the correspondences among files, groups, and packets in the case of the groups being resent once. In this example, file #1 is divided into the two groups of group data #1 and group data #2. Group data #1 is divided into a plurality of packets each consisting of a packet ID and actual data. This is the same with group data #2 through #n. As is not shown in FIG. 7, one group can include a plurality of files.

At this time the control data generating section 30c-2 generates file information shown in FIG. 6(B). This file information includes File Size 51a and File Name 51b. File Size 51a indicates the data capacity of a file. File Name 51b indicates the name of a file. If there are a plurality of files, information corresponding to each file is included in File Size 51a and File Name 51b.

[Step S3] The control data generating section 30c-2 generates destination information, being information regarding a delivery destination. FIG. 6(C) shows an example of destination information. In this example, destination information includes Number of Listed IP Addresses 52a, IP Address List Resending Times 52b, Number of Pieces of Data 52c, and IP Addresses 52d through 52n. Number of Listed IP Addresses 52a indicates the number of IP addresses included in IP Addresses 52d through 52n. IP Address List Resending Times 52b indicates the number of times the sending of IP Addresses 52d through 52n is repeated. Number of Pieces of Data 52c indicates the number of pieces of data included in IP Addresses 52d through 52n. IP Addresses 52d through 52n are IP addresses to which data is delivered. Multicast addresses are included in these IP addresses.

[Step S4] The control data generating section 30c-2 generates result notification information, being information for determining timing with which the delivery destination systems 32-1 through 32-n send notification of the delivery result in the case of receiving the data. That is to say, the control data generating section 30c-2 first writes pseudo data to the databases 30a and 30b and measures time taken to access these databases. Then the control data generating section 30c-2 measures the state of the load on a CPU (not shown) included in the delivery source system 30. And then the control data generating section 30c-2 calculates processing time t needed in the case of notification of the delivery result being given by a single delivery destination system from the access time and the state of the load on the CPU. Moreover, the control data generating section 30c-2 obtains total number of delivery destinations N, being the number of delivery destination systems to which the data is delivered, and multiplies them together to calculate total processing time T (T=t×N). Processing time T obtained is result notification information.

[Step S5] The communication control section 30c-5 generates control data by putting together the packet definition information, file information, destination information, and result notification information obtained in this way, and sends it to the delivery destination systems 32-1 through 32-n.

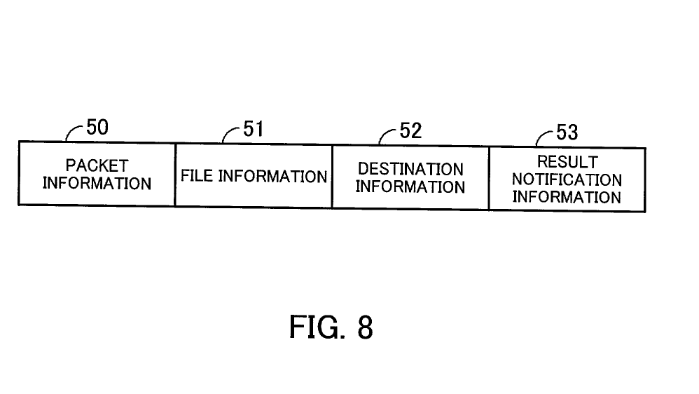

FIG. 8 is a view showing an example of control data sent to the delivery destination systems 32-1 through 32-n. As shown in FIG. 8, control data includes Packet Information 50, File Information 51, Destination Information 52, and Result Notification Information 53. This control data is sent via the network 31 to delivery destination systems described in Destination Information 52.

[Step S6] A delivery destination system which received the control data stores it in a database temporarily. If the delivery destination systems 32-1 through 32-n are taken as examples, the control data processing section 32c-2 temporarily stores the control data received by the communication control section 32c-5 in the database 32a.

[Step S7] The control data processing section 32c-2 gives the communication control section 32c-5 instructions to ensure buffer areas for receiving. To be concrete, the control data processing section 32c-2 refers to Packet Information 50 included in the control data, calculates the data capacity of a group, being a receiving unit, from Packet Size 50b and Total Number of Packets Included in One Group 50c, and gives the communication control section 32c-5 instructions to ensure a buffer with capacity corresponding to it.

[Step S8] When a certain period elapses after sending the control data, the communication control section 30c-5 in the delivery source system 30 sends the packets generated by the delivered packet generating section 30c-3 to a delivery destination system as actual data. If the number of times groups are resent is set to two or more, delivery of the groups will be repeated times set.

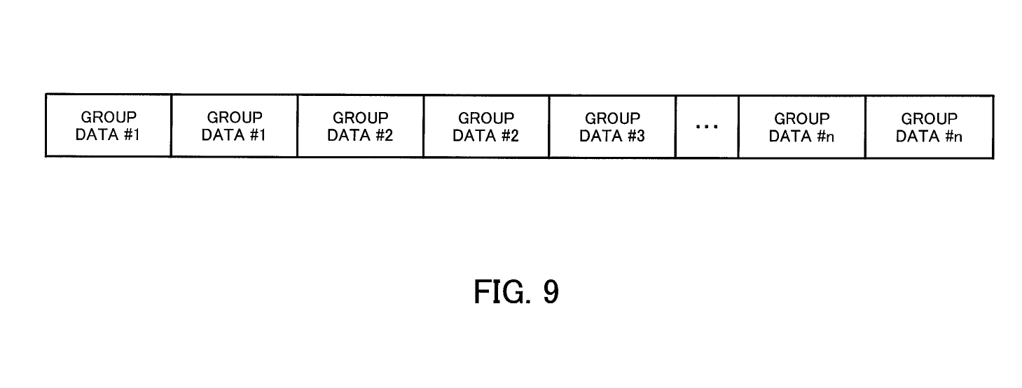

FIG. 9 is a view showing how groups are delivered in the case of the number of times groups are resent being set to two. In this example, group data #1 is delivered twice in succession. Similarly, group data #2 through #n are delivered twice in succession. Alternatively, groups can be shuffled together so that the same group will not be delivered twice in succession. This can prevent all of the same groups from including an error even if disturbance continues for a relatively long time.

[Step S9] The data receiving section 32c-3 receives the data delivered by the group and combines it again to generate the original file. That is to say, when the receiving of a predetermined group by the communication control section 32c-5 is completed, the data receiving section 32c-3 receives the group data and stores it in a predetermined area in the database 32b. When the next group is delivered, the data receiving section 32c-3 combines it and the group data the data receiving section 32c-3 previously received to generate the original file (the division is not yet made). If the number of times groups are resent is set to two or more and any group data includes an error, the same group data delivered separately from it is stored instead in the database 32b or the group in question is complemented by the same group data delivered separately from it. If the same group which does not include an error does not exist, this method cannot be adopted. In such a case, a request to resend the data will be made in step S10.

[Step S10] The delivery result processing section 32c-4 judges whether all of the groups could be received normally as a result of a receiving process by the data receiving section 32c-3 and generates notification of delivery result on the basis of the judgment.

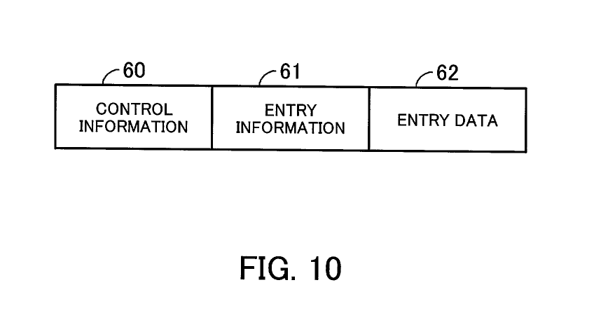

FIG. 10 is a view showing an example of notification of delivery result. As shown in FIG. 10, notification of delivery result includes Control Information 60, Entry Information 61, and Entry Data 62.

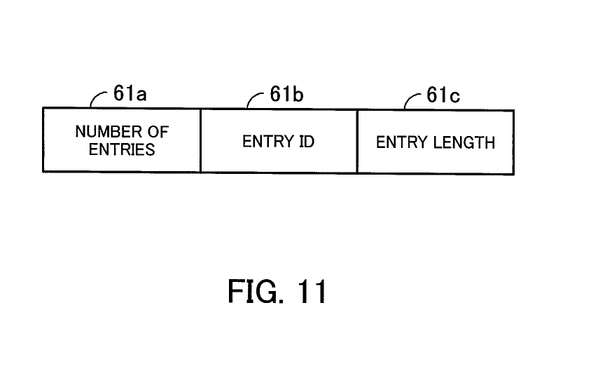

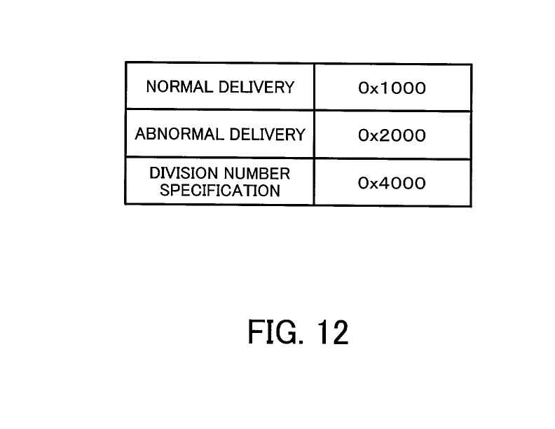

Control Information 60 is information, such as an identifier, total data length, and sending ID, necessary for communication control. As shown in FIG. 11, Entry Information 61 includes Number of Entries 61a, Entry ID 61b, and Entry Length 61c. Number of Entries 61a indicates the number of pieces of data included in Entry Data 62. As shown in FIG. 12, Entry ID 61b stores “0×1000” in the case of normal delivery and “0×2000” in the case of abnormal delivery. In addition, Entry ID 61b stores “0×4000” in the case of division number specification for indicating which divided file (group) could not be received normally.

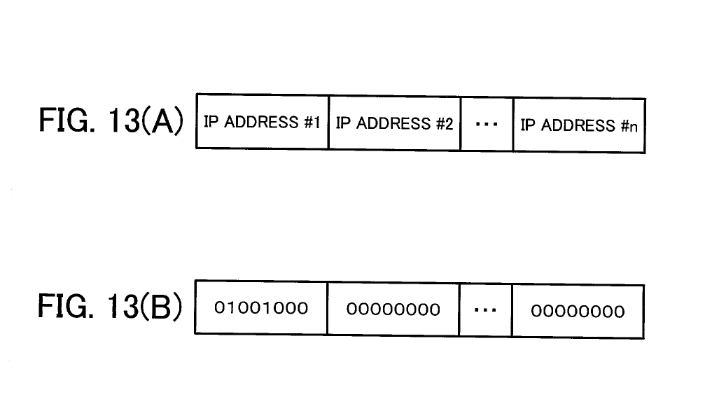

As shown in FIG. 13(A), Entry Data 62 stores the IP addresses of delivery destination systems where normal receiving was performed, in the case of normal delivery (if Entry ID 61b stores “0×1000”). As shown in FIG. 13(A), Entry Data 62 stores the IP addresses of delivery destination systems where abnormal receiving was performed, in the case of abnormal delivery (if Entry ID 61b stores “0×2000”). Moreover, in the case of division number specification being selected (if Entry ID 61b stores “0×4000”), the division numbers of divided files (groups) which could not be received normally are indicated by bits shown in FIG. 13(B). In this example, the second and fifth bits in the first 8-bit data are “1.” This indicates that divided files of division numbers #2 and #5 could not be received normally.

In this example, a plurality of IP addresses are stored in Entry Data 62 in the cases of normal and abnormal delivery. But in reality notification of delivery result sent from a single delivery destination system includes only its IP address. A router (not shown) which supervises a plurality of delivery destination systems will add a plurality of IP addresses in this way.

[Step S11] The delivery result processing section 32c-4 waits a predetermined time and then proceeds to step S12.

That is to say, the delivery result processing section 32c-4 first extracts the result notification information from the control data sent previously from the delivery source system 30. As was described in step S4, this result notification information is time T the delivery source system 30 needs for processing notification of delivery result sent from all of the delivery destination systems 32-1 through 32-n. The delivery result processing section 32c-4 initializes a random number with its own IP address as an initial value, generates random number R (O<R≦1), and obtains delivery result waiting time τ by multiplying random number R and time T together. IP addresses differ among different delivery destination systems, so delivery result waiting time τ obtained as a result of operations will be uniformly dispersed between 0 and T. Therefore, waiting delivery result waiting time τ will uniformly disperse responses from delivery destination systems between time 0 and T. This can prevent responses from being given simultaneously at a certain time.

[Step S12] The delivery result processing section 32c-4 causes the communication control section 32c-5 to send the notification of delivery result to the delivery source system 30 as a basic packet, being a basic unit for accounting. For example, if accounting on the network 31 is performed by the hundred bytes, then the notification of delivery result is converted into 100-byte packets and is delivered to the delivery source system 30. By generating packets according to an accounting unit in this way, the amount of fees charged to the delivery destination systems 32-1 through 32-n can be reduced.

[Step S13] The delivery result processing section 30c-4 refers to the notification of delivery result received by the communication control section 30c-5. If an abnormality occurred in delivery of the data, a divided file of the corresponding number or all of the divided files will be sent again to a delivery destination system (retry).

That is to say, in the case of abnormal delivery (if Entry ID 61b stores “0×2000”), all of the divided files will be delivered again to a specified IP address. In the case of division number specification being selected (if Entry ID 61b stores “0×4000”), only a divided file (group) which could not be received normally will be delivered again to all of the IP addresses.

In the above process, a file to be delivered is divided into a plurality of groups and a group is resent two or more times at need. Therefore, even if an error occurs on, for example, a communication line and a group cannot be received normally, the same group delivered separately from that group can be substituted for that group or complement that group.

Moreover, before actual data being delivered, control data is delivered to delivery destination systems in order to cause them to make preparations for receiving. Each delivery destination system therefore can prepare in advance the best environment which meets conditions, such as the amount of data delivered.

Furthermore, result notification information is sent to delivery destination systems and each delivery destination system determines delivery result waiting time by multiplying the result notification information and a random number together. This can prevent notification of delivery result from being given simultaneously at a certain time.

In addition, the delivery source system 30 delivers necessary data again on the basis of notification of delivery result. This enables delivery destination systems to receive entire data reliably.

Further, in the case of division number specification, only a specific group is resent. Compared with a case where entire data is resent, the load on the entire system can be reduced. In that case, it is possible to determine the data length of notification of delivery result on the basis of an accounting unit on a network and to determine the number of divided files from this data length.

A concrete example will now be given. It is assumed that accounting on the network 31 is performed by the hundred bytes. Then it is desirable, from the viewpoint that the load on a user should be reduced, that notification of delivery result is set to hundred bytes. If notification of delivery result is set to hundred bytes, then it includes eight hundred (=100×8) bits. The maximum number of divided files therefore is eight hundred.

As described above, by determining the data length of notification of delivery result and the number of divided files on the basis of an accounting unit, a communication fee each user pays can be cut.

In the above embodiment, if a plurality of files are delivered, delivery destination systems send notification of delivery result after they receive all of the files. However, they can send notification of delivery result each time delivery of a file is completed.

Furthermore, in the above embodiment, detailed descriptions of how to set the number of packets included in a group are not given. However, as will now be described, it can be set according to a system or communication line.

### EXAMPLE 1

Multicast delivery is made by the use of a satellite link and a delivery source system and delivery destination systems have high throughput.

1) Data packets are lost randomly on the satellite link. Packets are lost randomly and frequently especially under bad weather conditions.

2) A file is input to and output from the delivery source system at a sufficiently high speed and an increase in the number of times a file is input and output has little influence on its throughput.

3) A file is input to and output from the delivery destination systems at a sufficiently high speed. File input-output does not become a bottleneck and does not cause loss of data packets.

On the basis of 1), data packets to be lost are dispersed among all the packets. Even if the number of packet groups increases or reduces, the possibility that lost data packets can be complemented does not change.

On the basis of 2) and 3), an increase in the number of times a file is input and output has little influence on the throughput of the delivery source system and delivery destination systems. Therefore, the number of packets included in a group can be set so that many memory resources (buffer areas for sending and receiving) in the delivery source system and delivery destination systems will not be used. For example, if the size of buffers used by SOCKET, being an application programming interface (API) for network used for TCP/IP, is 8K bytes, optimum delivery control can be realized by setting the amount of data included in one group (total number of packets included in one group x amount of data included in each packet) to about 8K bytes.

### EXAMPLE 2

An input-output process in a delivery destination system becomes a bottleneck and data packets are lost.

1) Waiting time at the time of inputting to and outputting from a memory causes the loss of data packets.

On the basis of 1), data packets are lost in succession. Therefore, if the number of packets included in a group is small, there is a possibility that a lost data packet cannot be complemented by delivering data packets two or more times. Therefore, the possibility that data packets lost in succession can be complemented should be enhanced by increasing the number of packets included in a group as much as possible. Furthermore, buffer areas for receiving used for a data receiving process by a delivery destination system should be provided as much as possible. This can reduce the number of times a file is input and output and prevent loss of data packets caused by the file input-output.

In the case of Example 2, when a delivery destination system tries to ensure buffer areas for a receiving process on the basis of the amount of data included in one group which was determined by a delivery source system, memory resources in the delivery destination system may be exhausted. In order to avoid this problem, a delivery destination system should customize buffer areas for a receiving process according to memory resources in the system.

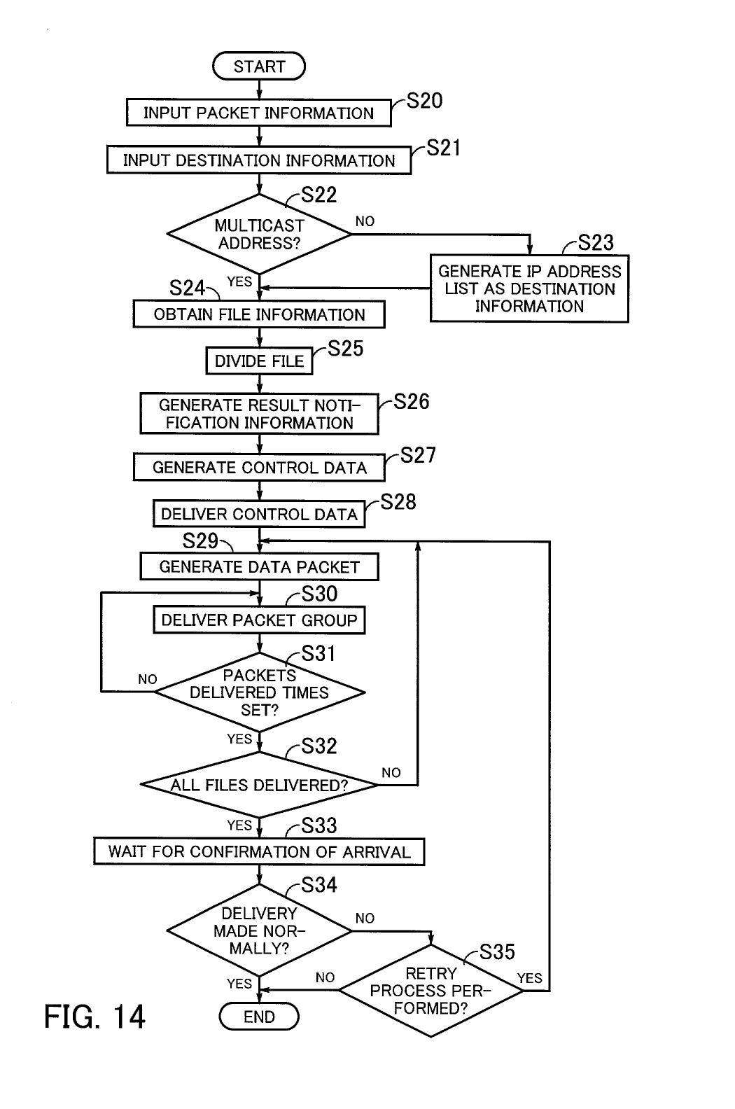

A flow chart performed in the embodiment shown in FIG. 2 will now be described with reference to FIGS. 14 through 17.

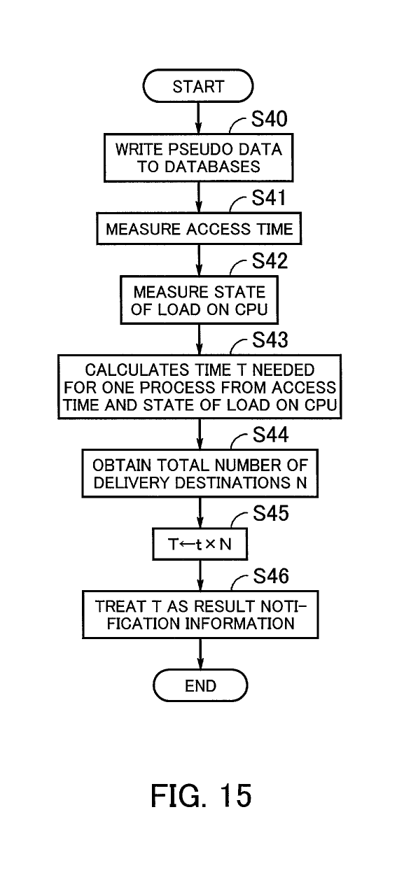

FIG. 14 is a flow chart performed in the delivery source system 30 shown in FIG. 3 in the case of delivering data by multicasting. The following steps will be performed according to this flow chart.

[Step S20] The data management section 30c-1 inputs packet information for data to be sent from the database 30a.

[Step S21] The data management section 30c-1 inputs destination information for the data to be sent from the database 30a.

[Step S22] The data management section 30c-1 refers to the destination information input in step S21 and judges whether the destination is a multicast address or not. If the destination is a multicast address, then step S24 is performed. If the destination is not a multicast address, then step S23 is performed.

[Step S23] The control data generating section 30c-2 generates an IP address list as destination information in which the IP addresses of delivery destination systems are enumerated.

[Step S24] The control data generating section 30c-2 obtains file information from the database 30a.

[Step S25] The delivered packet generating section 30c-3 obtains the data to be delivered from the database 30b and divides it into a plurality of groups by referring to the packet information.

[Step S26] The control data generating section 30c-2 generates result notification information. That is to say, the control data generating section 30c-2 measures time taken to access the databases 30a and 30b by writing pseudo data to these databases and measures the state of the load on a CPU (not shown). Then the control data generating section 30c-2 obtains the number of the delivery destination systems, being delivery destinations, refers to these pieces of information, and generates result notification information, being time needed for a process performed in the case of receiving notification of delivery result from all of the delivery destinations. The details of this process will be described later with reference to FIG. 15.

[Step S27] The control data generating section 30c-2 generates control data from Packet Information 50, File Information 51, Destination Information 52, and Result Notification Information 53.

[Step S28] The control data generating section 30c-2 delivers the control data to the target delivery destination systems via the communication control section 30c-5.

[Step S29] The delivered packet generating section 30c-3 refers to the previously sent packet information and file information and generates data packets by dividing a file to be sent.

[Step S30] The communication control section 30c-5 obtains predetermined packet groups generated by the delivered packet generating section 30c-3 and sends them to the delivery destination systems.

[Step S31] The communication control section 30c-5 judges whether packets included in the groups were delivered times set. If packets included in the groups were not delivered times set, then the process in step 30 is repeated. If packets included in the groups were delivered times set, then step S32 is performed.

[Step S32] The communication control section 30c-5 judges whether all of the files were delivered. If all of the files were delivered, then step S33 is performed. If there is a file which has not been delivered yet, then the process in step 29 is repeated.

[Step S33] The delivery result processing section 30c-4 waits for confirmation of arrival until notification of delivery result arrives from the delivery destination systems.

[Step S34] The delivery result processing section 30c-4 refers to notification of delivery result received from each delivery destination system and judges whether delivery was made normally. If delivery was made normally, then the procedure is terminated. If delivery was not made normally, then step S35 is performed.

[Step S35] The delivery result processing section 30c-4 judges whether a retry process should be performed. If a retry process is performed, then step S29 is performed. If a retry process is not performed, then the procedure is terminated.

A flow chart performed in the case of generating result notification information will now be described with reference to FIG. 15. The following steps will be performed according to this flow chart.

[Step S40] The control data generating section 30c-2 writes pseudo data to the databases 30a and 30b.

[Step S41] The control data generating section 30c-2 measures time needed for the writing process in step S40.

[Step S42] The control data generating section 30c-2 measures the state of the load on the CPU (not shown).

[Step S43] The control data generating section 30c-2 calculates processing time t needed in the case of notification of delivery result being given from a single delivery destination system from the access time obtained in step S41 and the state of the load on the CPU obtained in step S42.

[Step 44] The control data generating section 30c-2 obtains the total number of the delivery destinations N from the database 30a.

[Step S45] The control data generating section 30c-2 calculates total processing time T needed in the case of notification of delivery result being given from all of the delivery destinations by multiplying t and N together.

[Step S46] The control data generating section 30c-2 treats total processing time T obtained in step S45 as result notification information.

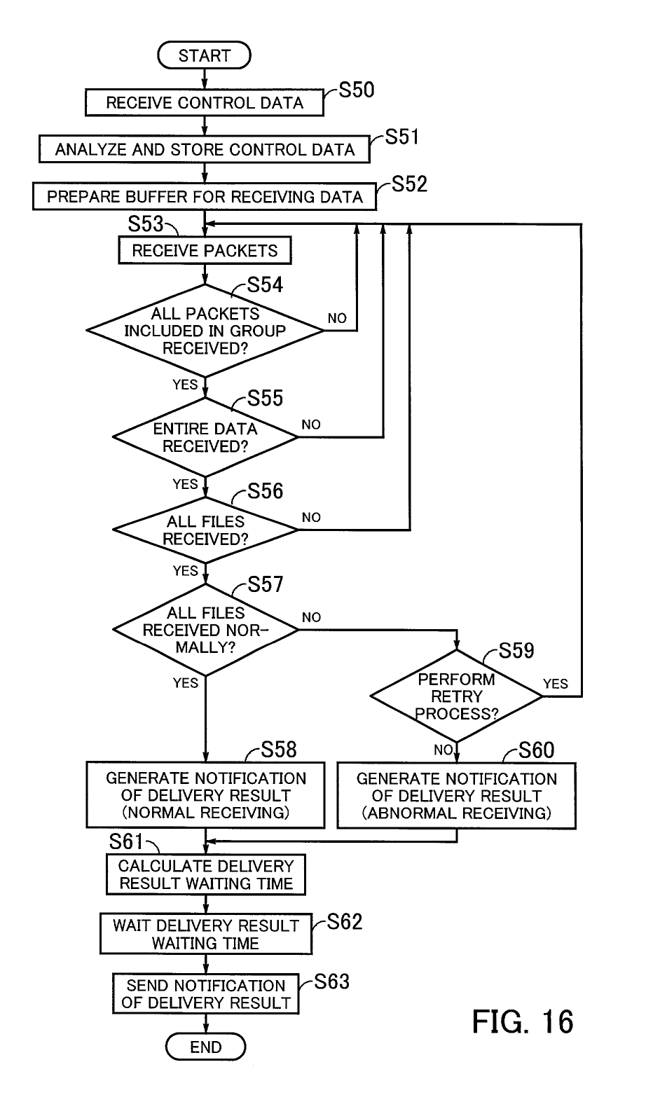

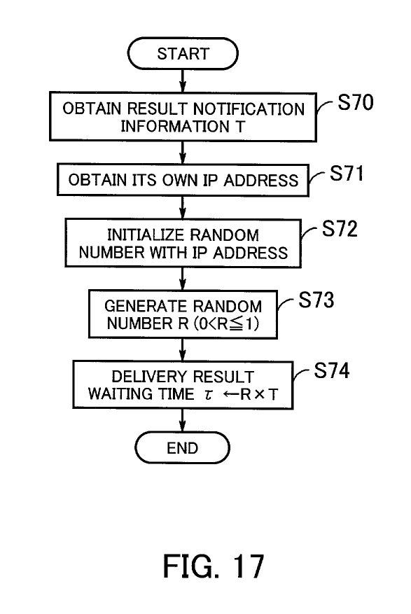

A flow chart performed in the case of the delivery destination systems 32-1 through 32-n shown in FIG. 4 receiving delivered data will now be described with reference to FIG. 16. The following steps will be performed according to this flow chart.

[Step S50] The control data processing section 32c-2 receives control data via the communication control section 32c-5.

[Step S51] The control data processing section 32c-2 analyzes the control data and stores it in the database 32a.

[Step S52] The control data processing section 32c-2 refers to the control data and causes the communication control section 32c-5 to prepare a buffer for receiving data. That is to say, the control data processing section 32c-2 causes the communication control section 32c-5 to prepare a buffer corresponding to data capacity per group obtained by multiplying the size of a packet and the total number of packets included in one group together.

[Step S53] The data receiving section 32c-3 receives packets via the communication control section 32c-5 which are delivered from the delivery source system 30.

[Step S54] The data receiving section 32c-3 judges whether all of the packets included in a group were received. If all of the packets included in the group were received, then step S55 is performed. If there is a packet which has not been received yet, then the process in step S53 is repeated.

[Step S55] The data receiving section 32c-3 judges whether the entire group data included in a file was received. If the entire group data included in the file was received, then step S56 is performed. If there is group data which has not been received yet, then the process in step S53 is repeated.

[Step S56] The data receiving section 32c-3 judges whether all of the files were received. If all of the files were received, then step S57 is performed. If there is a file which has not been received yet, then the process in step S53 is repeated.

[Step S57] The delivery result processing section 32c-4 judges whether all of the files were received normally. If all of the files were received normally, then step S58 is performed. If there is a file which was not received normally, then step S59 is performed.

[Step S58] The delivery result processing section 32c-4 generates notification of delivery result which indicates that the result of the receiving is normal. To be concrete, if division number specification is selected, all of the bits are set to “0.” If division number specification is not selected, “0×1000” is selected and notification of delivery result is generated.

[Step S59] The delivery result processing section 32c-4 judges whether a retry process needs to be performed. If a retry process needs to be performed, then the process in step S53 is repeated. If a retry process does not need to be performed, then step S60 is performed.

[Step S60] The delivery result processing section 32c-4 generates notification of delivery result which indicates that the result of the receiving is abnormal. To be concrete, if division number specification is selected, the corresponding bits are set to “1.” If division number specification is not selected, “0×2000” is selected and notification of delivery result is generated.

[Step S61] The delivery result processing section 32c-4 calculates delivery result waiting time from result notification information and a random number. To be concrete, the delivery result processing section 32c-4 calculates delivery result waiting time by initializing a random number with its own IP address and multiplying result notification information and the random number together. The details of this process will be described later with reference to FIG. 17.

[Step S62] The delivery result processing section 32c-4 waits the delivery result waiting time calculated in step S61 and then proceeds to step S63.

[Step S63] The delivery result processing section 32c-4 sends the notification of delivery result to the delivery source system 30.

A flow chart performed in the case of calculating delivery result waiting time will now be described with reference to FIG. 17. The following steps will be performed according to this flow chart.

[Step S70] The delivery result processing section 32c-4 obtains result notification information T from the database 32a.

[Step S71] The delivery result processing section 32c-4 obtains its own IP address.

[Step S72] The delivery result processing section 32c-4 initializes a random number with its own IP address it obtained in step S71. IP addresses differ among different delivery destination systems, so random numbers generated in different delivery destination systems will differ from one another.

[Step S73] The delivery result processing section 32c-4 generates random number R (O<R≦1).

[Step S74] The delivery result processing section 32c-4 calculates delivery result waiting time τ by multiplying random number R and result notification information T together. As a result, delivery result waiting time τ calculated differs among different delivery destination systems and is uniformly dispersed between 0 and T. This can prevent congestion of notification of delivery result.

As described above, the flow charts shown in FIGS. 14 through 17 make it possible to realize the function of this embodiment which was described with reference to FIG. 2.

In the above embodiment, a case where data is multicasted via the network 31 was described. However, it is needless to say that satellite communication, for example, can be used in place of the network 31.

Moreover, in this embodiment, only judgments about the normality of received data were made. However, notification of delivery result may also be made when some error occurs in, for example, the adaptive process of installing a received file on a system. In such an embodiment, even if an error occurs in an adaptive process, a file can be installed normally by receiving data again from the delivery source system 30.

Further, in this embodiment, if an error occurs, data is delivered again by the group. However, it is possible to designate only a specific packet where an error occurred and to deliver data again. This will lead to a reduction in the amount of data to be delivered at the time of redelivery and the load on the entire system will be reduced.

The above process can be performed with a computer. In that case, the contents of functions which a delivery source system and delivery destination systems should have are described in a program recorded on a computer-readable record medium. The above functions can be realized with a computer by executing this program on the computer. A computer-readable record medium can be a magnetic recording device, a semiconductor memory, or the like. In order to place this program on the market, it can be stored on a portable record medium, such as a compact disk read only memory (CD-ROM) or a flexible disk. Alternatively, it can be stored in a memory of a computer connected via a network and be transferred to another computer via the network. When this program is executed on a computer, it is stored on a hard disk etc. in the computer and is loaded into a main memory.

As has been described in the foregoing, in the present invention, a computer functions as group generating means for generating groups including at least one data packet from a group of data packets to be delivered, as delivery times determining means for determining the number of times each of the groups generated by the group generating means is delivered, and as delivering means for repeating delivery of each of the groups generated by the group generating means times determined by the delivery times determining means. As a result, data can be delivered reliably even if a data packet is lost in multicast delivery.

Further, a computer functions as control information receiving means for receiving control information delivered from a delivery source before a data packet, as receiving preparing means for preparing receiving a data packet according to the control information, and as data packet receiving means for receiving a data packet delivered from the delivery source after the control information. As a result, data can be received smoothly in multicast delivery.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A computer-readable record medium that stores a program for making a computer perform the multicast process of delivering information to a plurality of delivery destinations like broadcasting, the program making a computer function as:
a group generating unit for generating groups including at least one data packet from a group of data packets to be delivered;
a delivery times determining unit for determining the number of times each of the groups generated by the group generating unit is delivered; and
a delivering unit for repeating delivery of each of the groups generated by the group generating unit times determined by the delivery times determining unit.

2. The record medium according to claim 1, wherein the group generating unit determines the number of data packets included in each group according to the state of a communication line or delivery destination.

3. The record medium according to claim 1, wherein the group generating unit determines the total amount of data included in each of data packets included in each group according to the state of a communication line or delivery destination.

4. The record medium according to claim 1, further storing a program for making a computer function as a control information delivering unit for delivering control information necessary for exercising control in the case of receiving data to be delivered before delivering the data by the delivering unit.

5. The record medium according to claim 4, further storing a program for making a computer function as:
a congestion state measuring unit for measuring the congestion state of a system;
a delivery destination number specifying unit for specifying the number of delivery destinations to which data is delivered; and
a processing time calculating unit for referring to the congested state and the number of the delivery destinations and for calculating time needed for a process performed in the case of responses being given by the delivery destinations,
wherein the control information delivering unit delivers the control information including the processing time calculated by the processing time calculating unit to help to determine waiting time before the delivery destinations responding.

6. The record medium according to claim 5, wherein the congestion state measuring unit measures the congestion state of a system on the basis of time needed for accessing a memory and the state of the load on a processor.

7. The record medium according to claim 1, further storing a program for making a computer function as a redelivering unit for redelivering a corresponding portion of a previously delivered data packet at need in the case of having received information regarding a state in which the data packet was received from a predetermined delivery destination.

8. A multicast delivery method for delivering information to a plurality of delivery destinations like broadcasting, the method comprising:
a group generating step for generating groups including at least one data packet from a group of data packets to be delivered;
a delivery times determining step for determining the number of times each of the groups generated by the group generating step is delivered; and
a delivering step for repeating delivery of each of the groups generated by the group generating step times determined by the delivery times determining step.

9. A computer-readable record medium that stores a program for making a computer perform the process of receiving data packets multicasted from a delivery source, the program making a computer function as:
a control information receiving unit for receiving control information delivered from the delivery source before a data packet;
a receiving preparing unit for preparing receiving the data packet according to the control information; and
a data packet receiving unit for receiving the data packet delivered from the delivery source after the control information.

10. The record medium according to claim 9, further storing a program for making a computer function as:
a received data quality judging unit for judging whether a data packet was received normally by the data packet receiving unit; and
a judgment responding unit for sending information indicative of a judgment made by the received data quality judging unit to the delivery source in the form of a packet as a basic unit for accounting.

11. The record medium according to claim 10, further storing a program for making a computer function as:
a processing time extracting unit for extracting processing time the delivery source will need for processing responses given by all of the delivery destinations from the control information; and
a waiting time calculating unit for calculating waiting time before the judgment responding unit responding by multiplying the processing time and a random number together.

12. A multicast receiving method for receiving data packets multicasted from a delivery source, the method comprising:
a control information receiving step for receiving control information delivered from the delivery source before a data packet;
a receiving preparing step for preparing receiving the data packet according to the control information; and
a data packet receiving step for receiving the data packet delivered from the delivery source after the control information.
